(19) United States
(12) Patent Application Publication
(10) Pub. No.: US 2001/0021116 A1
(43) Pub. Date: Sep. 13, 2001

(54) Converter motor with an energy recovery capability

(75) Inventors: Manfred Bruckmann, Nuernberg (DE); Bernhard Piepenbreier, Hemhofen (DE); Walter Springmann, Adelsdorf (DE)

Correspondence Address: Baker Botts L.L.P., 30 Rockefeller Plaza, New York, NY, 10112-4498, US

(73) Assignee: SIEMENS AG.

(21) Appl. No.: 09/801,552

(22) Filed: Mar. 8, 2001

(30) Foreign Application Priority Data
Mar. 9, 2000 (DE) 100 11 518.7
Mar. 9, 2000 (DE) 200 04 437.0

(51) Int. Cl. H02M 5/00

(52) U.S. Cl. 363/157

(57) ABSTRACT

The present invention relates to a converter motor with an energy recovery capability, comprising a motor and a self-commutating direct converter, the use of which results in a compact converter motor with an energy recovery capability, which can be used as a four-quadrant drive.

### BACKGROUND OF THE INVENTION

The invention relates to a converter motor with an energy recovery capability, comprising a motor and a converter.

Variable speed drives in a compact form have been commercially available for some years as integrated converter motors in which the converter and motor form a physical unit. This space-saving solution avoids long motor cables with pulse-frequency power signals.

Typically, a standard asynchronous motor is used as the motor and a frequency changer with a voltage intermediate circuit and diode feed is used as the converter. The voltage intermediate circuit converter requires a relatively large capacitor for capacitive smoothing of the intermediate circuit voltage and, with the present-day technology, this capacitor can be provided only by using electrolytic capacitors. The drawbacks of this system include the following:

limited life of the electrolytic capacitors;

the electrolytic capacitors result in the converter having a large volume;

no possibility of energy recovery; and

generator braking is possible only by using a resistor chopper braking unit, thereby enlarging the physical volume of the converter motor.

The combination of two power-loss sources to form one mechanical unit increases the power-loss density and thus the temperature of the unit. While, the power losses are generally dominant. The increase in the temperature of the unit results in more stringent requirements being placed on the components. Moreover, since the wet electrolyte in the capacitor in the voltage intermediate circuit converter ages faster at a raised temperature, operation above an ambient temperature of about 80° C. is impossible, since even high-quality electrolytic capacitors cannot satisfy the useful-life requirements placed on them.

In relatively modem converter motors, the conventional, large electrolytic capacitors are replaced by low-cost alternating-current capacitors and, at the same time, the intermediate circuit capacitance of the voltage intermediate circuit converter is reduced. These capacitors are also less sensitive to temperature. This reduction in the intermediate circuit capacitance leads, however, to a lower mean intermediate circuit voltage, which in turn reduces the maximum motor output voltage, so that the weak-field region of this converter motor starts earlier.

Furthermore, without electrolytic capacitors, no significant amount of energy can be buffered in the intermediate circuit during generator operation (braking operation). Since the capacitance is too low, the intermediate circuit voltage rises too rapidly to enable any overvoltage protection device to operate. These converter motors are thus predominantly suitable for motor operation, for example as a pump drive and a resistor chopper braking unit must therefore be provided wherever generator braking processes are required. Such a unit is mounted, for example, on the converter, thus taking up even more space, contrary to the concept of a compact drive.

In order to obtain a compact drive, the converter in the converter motor must be designed in an extremely space-saving manner. The present invention is based on the object of developing the known converter motor such that a compact drive is produced.

### SUMMARY OF THE INVENTION

According to the present invention, a self-commutating direct converter is used as the converter. The use of a self-commutating direct converter, which is also referred to as a matrix converter, reduces the physical volume of the converter to such an extent that it can be integrated in an enlarged terminal box on the motor. The matrix converter is a frequency changer without an intermediate circuit. The arrangement of electronic power switches in a 3×3 switch matrix results in the input phases being connected to the output phases. The self-commutating direct converter offers the advantage that, depending on the topology, it has an energy recovery capability and, depending on a control system, achieves a virtually sinusoidal mains current draw. No electrolytic capacitors, (having the useful life problems mentioned above), are used in the power section of the self-commutating direct converter.

In one preferred embodiment of the converter motor, the converter is a self-commutating direct converter which has delta-connected varistors as overvoltage protection apparatuses on the mains and load sides. A robust matrix converter is thus accommodated in an enlarged terminal box on the motor, and even any overvoltage which occurs on EMERGENCY OFF does not lead to destruction of the electronic power switches.

The invention will be explained further with reference to the drawing, which illustrates schematically a number of embodiments of a converter motor according to the invention, and in which:

### BRIEF DESCRIPTION OF THE DRAWING

FIG. 1 shows a perspective illustration of a known converter motor.

FIG. 2 shows an electrical equivalent circuit of a self-commutating direct converter.

FIG. 3 shows an electrical equivalent circuit of a preferred embodiment of a converter motor according to the invention.

FIGS. 4 to 9 show various variations of the positioning of the converter on the motor.

### DETAILED DESCRIPTION OF PREFERRED EMBODIMENTS

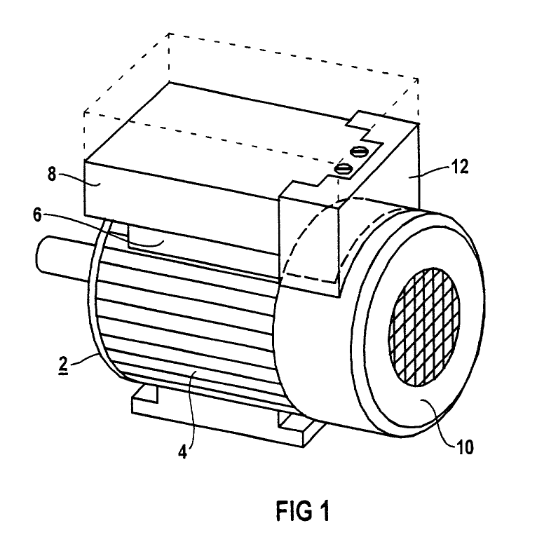

A converter motor as shown in FIG. 1 is known from DE 196 18 996 A1. Referring to FIG. 1, an electrical machine 2 is provided, in which a terminal box 6 is arranged on the top face of the machine's housing 4. A converter 8, in particular a voltage intermediate circuit converter, for controlling the speed of the machine 2 is connected to this terminal box 6. This type of converter is also referred to commercially as a frequency changer. A machine fan, which is surrounded by a fan shroud 10, is arranged on the machine shaft on the end face, facing away from the drive side of the machine 2. An outward bulge 12, which points radially outward, is integrally formed on the fan shroud 10, and its radial height and circumferential extent are matched to the height and width of the converter 8. A portion of the cooling air flow is passed to the converter 8 by means of this outward bulge. This results in better cooling of the power electronics of the converter 8. The electrical machine 2 is a standard asynchronous motor, in particular a three-phase low-voltage motor.

The converter 8 is a voltage intermediate circuit converter with pulse-width-modulated outputs. According to the block diagram in FIG. 15 of the Siemens Catalog DA 64,1998/99, entitled “MICROMASTER, MICROMASTER Vector, MIDIMASTER Vector, COMBIMASTER”, this voltage intermediate circuit converter has a three-phase diode bridge with mains filters that are available as accessories, high-temperature-resistant intermediate circuit capacitors, and a pulse inverter with Insulated Gate Biopolar Transistors (IGBT). A microprocessor is provided as the regulation and control device.

The installation location of a pulsed-resistance brake is indicated by means of dashed lines in FIG. 1. This pulsed-resistance brake is required as soon as the machine 2 is braked in the generator mode. The generator braking results in motor energy recovery, which leads to a voltage rise in the DC voltage intermediate circuit. As soon as a predetermined threshold value is reached, the electronics for the pulsed-resistance brake connect the braking resistor in parallel with the intermediate circuit capacitor. The energy which is recovered propagates as heat in the resistor, thus preventing overvoltage tripping. While the resistor is switched on, its temperature rises. When a predetermined threshold temperature is reached, the electronics limit the power in the resistor to a predetermined value for the peak power. If its temperature rises further, then the resistor is switched off completely. An illustration of such a pulsed resistance brake is shown in FIG. 8.8.3 of the aforementioned catalog. Furthermore, FIG. 6 in the catalog shows the dimensions of the converter, of the converter with mechanical brake control, and/or with a resistance braking unit. From these it can be seen how the physical height of the converter 8, and thus of the converter motor, changes.

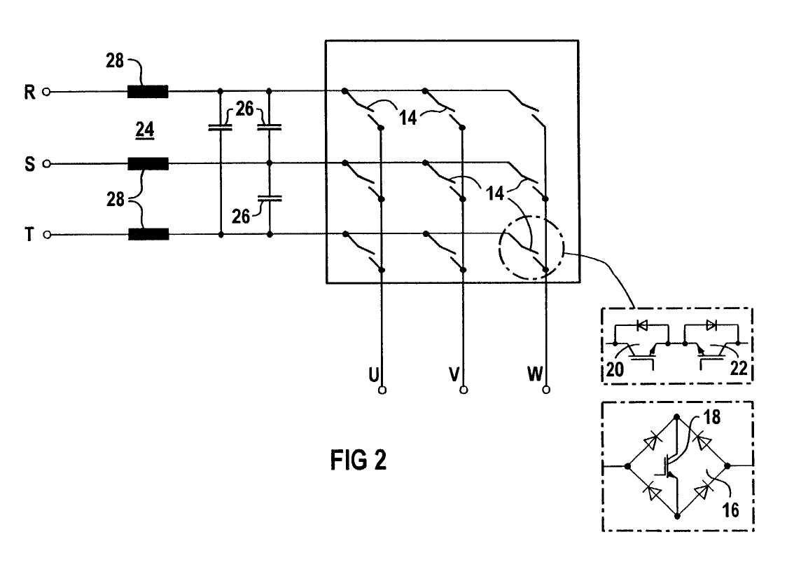

FIG. 2 shows an electrical equivalent circuit of a self-commutating direct converter. This self-commutating direct converter is a frequency changer without an intermediate circuit. The arrangement of the electronic power switches 14 in a 3×3 switch matrix results in the three input phases R, S and T being connected to the three output phases U, V and W. This self-commutating direct converter offers the advantage that, depending on the topology, it has an energy recovery capability, and appropriately designed control results in sinusoidal mains currents. A semiconductor switch 18 integrated in a diode bridge 16, on the one hand, and two semiconductor switches 20 and 22, connected back-to-back in series, on the other hand, can be used as bidirectional switches 14 in the switch matrix. The two semiconductor switches 20, 22 which are connected back-to-back in series in a bidirectional power switch 14 in the switch matrix are designed using either the “common emitter mode” or “common collector mode” topology. IGBTs are preferably used as the semiconductor switches 18 and 20, 22. Actuation of the semiconductor switches 18 and 20, 22 in the power switches 14 in the switch matrix in each case results in a current path being formed in a direction governed by the arrangement of the semiconductor switches 18 and 20, 22. One phase of the matrix converter is an arrangement of three bidirectional power switches 14, which produce a connection from three mains phases R, S and T to a respective one of the output phases U, V and W.

Since the matrix converter does not have any freewheeling circuits, such as a voltage intermediate circuit converter, the inductances which are present in the circuit result in high reverse voltages across the semiconductor switches 18 and 20, 22, particularly in the case of a pulse inhibit generated as a result of an EMERGENCY OFF (for the actuating pulses to all the semiconductor switches 18 and 20, 22 in the power switches 14 to be switched off). These overvoltages can also occur as a result of an incorrectly initiated commutation sequence, or due to failure of the actuation of bidirectional power switches 14. The output circuit is always interrupted in these situations. The interruption of the output circuit in conjunction with the inductances which are present in the circuit causes the overvoltage, which can result in destruction of the semiconductor switches 18 and 20, 22.

Measures to counteract the problem which have been mentioned are known from the literature, and these require a greater or lesser amount of space. From the point of view of the converter 8 for the converter motor occupying as little space as possible, the only overvoltage protection apparatuses which may be used are those which do not consume the space which has been gained by replacing the voltage intermediate circuit converter by a self-commutating direct converter.

The circuit shown in FIG. 2 shows a self-commutating direct converter being linked to an LC filter 24 on the mains side. This LC filter 24 ensures that voltage spikes occurring as a result of switching operations remain limited to the power switches 14. In addition, this results in defined conditions with respect to the mains, and the pulsed input current of the matrix converter is smoothed.

The LC filter 24 has commutation capacitors 26 and inductances 28. The commutation capacitors 26 are connected between the input phases R, S and T. The capacitors 26 can also be connected in a star. The inductances 28 are connected in the lines between the capacitors 26 and the connections on the mains side. The charging currents for the commutation capacitors 26 are thus smoothed. Foil capacitors, which have a considerably longer life than electrolytic capacitors, are used as the capacitors 26. In this way, a desired, long useful life can be achieved. Since these capacitors 26 have very low capacitance values, these capacitors 26 occupy scarcely any space, so that the self-commutating direct converter is very compact.

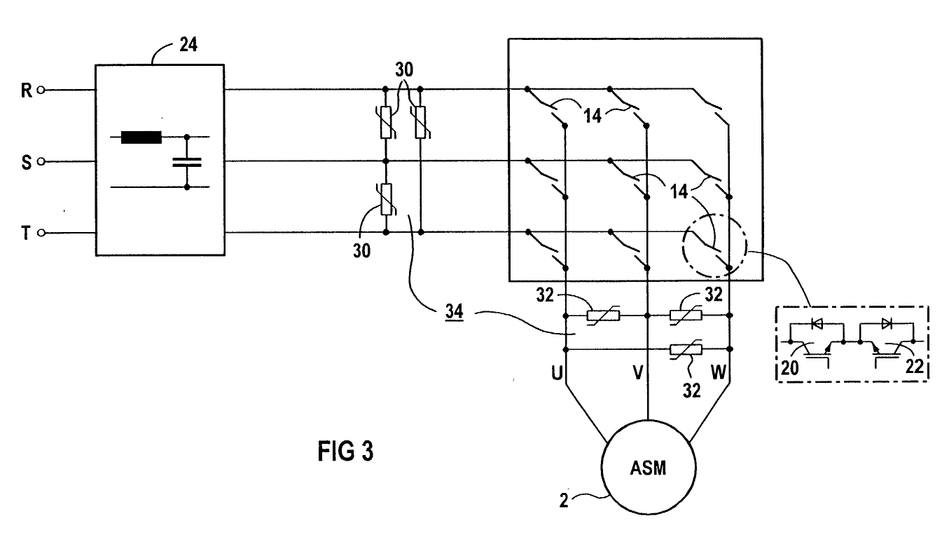

FIG. 3 shows another preferred embodiment of the self-commutating direct converter shown in FIG. 2. This embodiment differs from the embodiment shown in FIG. 2 in that delta-connected varistors 30 and 32 are provided as an overvoltage protection apparatus 34. These varistors 30 and 32 are commercially available. Each varistor 30 or 32 is connected electrically in parallel with two bidirectional power switches 14 in the matrix converter. In an “EMERGENCY OFF” fault situation, in which all the semiconductor switches 18 and 20, 22 in the bidirectional power switches 14 in the matrix converter are switched off, the varistors 30 and 32 each offer a current path in order to eliminates the small amount of energy being recovered by the asynchronous machine 2 in the converter motor. As a consequence, it is impossible for any overvoltage to occur across the semiconductor switches 18 and 20, 22 in the bidirectional power switches 14 in the self-commutating direct converter. This results in a very compact converter 8 which, for example, which can now be integrated in a slightly enlarged terminal box 6 on the electrical machine 2.

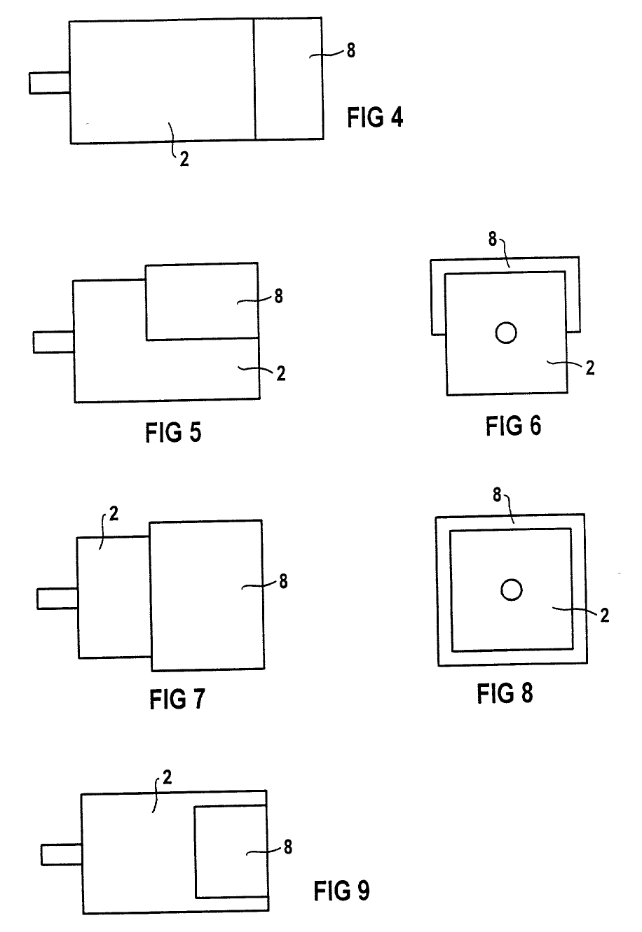

The compact converter 8 can, as shown in FIG. 4, also be integrated in a housing which is fitted to one end face of the machine 2. This housing is designed such that its cross-sectional area is equal to the cross-sectional area of the machine 2. As shown in FIGS. 5 and 6, the compact converter 8 can also be accommodated in a housing which is fitted around a portion of the surface of the machine housing 4 of the machine 2. This results in scarcely any increase in the cross-sectional area of the machine 2. As shown in FIGS. 7 and 8, this housing can also be arranged around the entire surface of the housing 4 of the machine 2. This allows the entire surface area of the machine housing 4 to be used as a cooling surface. It is even possible, as shown in FIG. 9, for the compact converter 8 to be integrated in the machine 2.

Since the self-commutating direct converter has an energy recovery capability by virtue of its topology, the converter motor according to the invention now provides a compact 4-quadrant drive. In addition, there is no longer any need for a pulsed resistance braking unit to convert the energy which has been recovered into heat. The compactness of the converter 8 now results in there being no need for the lines between the pulse inverter of the converter 8 and the motor windings of the machine 2, so that reflection processes no longer occur. The complexity for spark suppression is thus reduced, and the semiconductor switches 18 and 20, 22 in the power switches 14 in the self-commutating direct converter can be selected to have a reduced switching rating. Furthermore, there is no need for output filters, which are also referred to as dv/dt filters.

1. A converter motor having an energy recovery capability, comprising a motor and a converter which form a physical unit, wherein the converter is a self-commutating direct converter.

2. The converter motor as claimed in claim 1, wherein the self-commutating direct converter has delta-connected varistors for overvoltage protection.

3. The converter motor as claimed in claim 1 wherein the motor is a standard asynchronous motor.

4. The converter motor as claimed in claim 1 wherein the motor is a synchronous motor.

5. The converter motor as claimed in claim 1 wherein the self-commutating direct converter is integrated in an enlarged terminal box on the motor.

6. The converter motor as claimed in claim 1 wherein the self-commutating direct converter is detachably mounted on the end face of the motor.

7. The converter motor as claimed in claim 1 wherein the self-commutating direct converter is integrated in a housing which is at least partially arranged along the circumference of the motor.

8. The converter motor as claimed in one of the preceding claim 1 wherein the self-commutating direct converter is integrated in the motor.
